(19) United States
(12) Patent Application Publication
(10) Pub. No.: US 2025/0265822 A1
(43) Pub. Date: Aug. 21, 2025

(54) TRANSFERRING KNOWLEDGE FROM A TEACHER NEURAL NETWORK TO A STUDENT NEURAL NETWORK

(71) Applicant: Robert Bosch GmbH, Stuttgart (DE)

(72) Inventors: Yumeng Li, Barcelona (ES); Anna Khoreva, Berlin (DE); Dan Zhang, Leonberg (DE)

(21) Appl. No.: 19/047,957

(22) Filed: Feb. 7, 2025

(30) Foreign Application Priority Data
Feb. 15, 2024 (EP) 24 15 7954.9

(51) Int. Cl. G06V 10/774; G06V 10/776; G06V 10/82

(52) U.S. Cl. CPC G06V 10/774; G06V 10/776; G06V 10/82

(57) ABSTRACT

A method for training a student neural network to adopt the behavior of a teacher neural network that is trained to perform a given processing on input images. The method includes: providing a set of training images; producing, from training image(s), one or more style-augmented versions that have the same semantic content as the original training image but differ from the original training image in their style; processing the training images and the augmented versions by the teacher neural network, and by the student neural network; evaluating, using a predetermined loss function, to which extent outputs and/or intermediate work products produced by the student neural network from each image are in agreement with the outputs and/or intermediate work products produced by the teacher neural network from the same image; and optimizing parameters that characterize the behavior of the student neural network.

### CROSS REFERENCE

The present application claims the benefit under 35 U.S.C. § 119 of European Patent Application No. EP 24 15 7954.9 filed on Feb. 15, 2024, which is expressly incorporated herein by reference in its entirety.

### FIELD

The present invention relates to the training of student neural networks having a smaller architecture based on the knowledge of a given already trained teacher network with a larger architecture.

### BACKGROUND INFORMATION

During the training of a neural network, the learned knowledge is stored in parameters that characterize the behavior of the neural network. The capacity for storing knowledge is therefore commensurate with the number of trainable parameters. So-called foundation models comprise very many parameters and have been trained with massive amounts of data. Examples for such foundation models include the CLIP model (Contrastive Language-Image Pre-Training) that learns the correspondence between natural language and images and the SAM model (Segment Anything Model) that can cut out any object out of any image.

Due to the large number of parameters, the use of a large foundation model for real-world applications can be computationally expensive and slow. In particular, the model will have to fit into mass storage at rest and into RAM when in use. For applications that run on hardware platforms that do not admit the use of the full foundation model due to lack of resources, student models with a smaller architecture are trained to mimic the behavior of the large foundation model that is then termed teacher model. If a sufficiently large set of training examples is used and the student model basically gives the same output as the teacher model for each of them, then the trained student model may be used as a fast, resource-saving, but still sufficiently accurate approximation for the teacher model.

### SUMMARY

The present invention provides a method for training a student neural network to adopt the behavior of a given teacher neural network. This given teacher neural network is trained to perform a given processing on input images.

According to an example embodiment of the present invention, in the course of the method, a set of training images x is provided. These training images x may be labelled with “ground truth” for the outputs that the student network should produce from them, but this is not required.

From at least one training image x, one or more style-augmented versions x′ are produced. These style-augmented versions x′ have the same semantic content as the original training image x. That is, in the context of the application at hand, the style-augmented versions x′ have the same meaning as the original training image x. The style-augmented versions x′ differ from the original training image x in their style. That is, style-augmented versions x′ represent different manners of rendering said same semantic meaning of the original training image x.

The training images x and the augmented versions x′ are processed by the teacher neural network on the one hand, and by the student neural network on the one hand. This causes the teacher neural network and the student neural network to produce respective outputs. While producing these outputs, the teacher neural network and the student neural network generate intermediate work products. In particular, in a network that is organized into layers or other building blocks, the output of one such layer or building block may be regarded as an intermediate work product that is passed to the next layer or building block.

According to an example embodiment of the present invention, using a predetermined loss function, it is then evaluated to which extent outputs and/or intermediate work products produced by the student neural network from each image x, x′ are in agreement with the outputs and/or intermediate work products produced by the teacher neural network from the same image x, x′. Parameters that characterize the behavior of the student neural network are then optimized towards the goal of improving the value of the loss function. These parameters may also include parameters that relate to the architecture of the student network itself. That is, the method not only serves to train a student neural network of a fixed architecture, but may also be used as a tool for Neural Architecture Search, NAS.

It was found that the augmentation of the training images x by changing their style significantly expands the manifold of images on which it is evaluated whether the behavior of the student neural network corresponds to that of the teacher neural network as intended. If this manifold is sufficiently large, then it can be expected that the behavior of the student neural network will also sufficiently agree with that of the teacher neural network for input images unseen during training of the student neural network. Every new notion of style change that is put onto the training images x effectively adds the complete number of training images x to the final training dataset again.

Moreover, the data augmentation in this manner is not dependent on the concrete task that is being solved with the teacher neural network and the student neural network. This means that the method is not limited to, e.g., neural networks that are used for image classification (i.e., attributing classification scores with respect to one or more classes to the image as a whole). This also means that the student neural network may even solve a task that is different from the one solved by the teacher neural network.

Herein, the determination of whether outputs and/or intermediate work products “are in agreement” is not limited to a 1:1 comparison. Such a 1:1 comparison is not even possible in all cases. Since the student neural network is typically of a much smaller architecture than the teacher neural network, the outputs, and in particular the intermediate work products, of the student neural network will be of a different dimensionality (i.e., vectors or tensors of different sizes) than those of the teacher neural network. For example, aggregate quantities and/or statistical quantities may be computed from the outputs and/or intermediate work products, and these aggregate quantities and/or statistical quantities may be compared.

By means of the augmented training dataset that contains augmented versions x′ of training images x on top of those training images x, the tendency of the training of the student neural network to overfit on the training images x is reduced. Typically, the dataset of the training images x is much smaller than the dataset of training images used for training the teacher neural network. For example, in an application where performance of a student neural network in the task of semantically segmenting images of city scenes is relevant, the prime training dataset Cityscapes for this application comprises only 2795 training images, and they all relate to situations in clear day. Without the data augmentation, it would be hard, if not impossible, to generalize the training of the student model to, e.g., nighttime, rain or snowy conditions.

In a particularly advantageous example embodiment of the present invention, producing an augmented version x′ of a training image x comprises:
extracting, from the training image x, a content c;
obtaining, based at least in part on a style source image y, a style s; and
processing, by a trained generative model G, the semantic content c and the style s into the sought augmented version x′.

In this manner, the content c from the training image x is mixed with the style s from the style source image y. This means that the new style s to be applied to the training image x need not be formulated explicitly. Rather, it can be supplied in an implicit manner in the form of the style source image y. This means that the style source image y may also comprise multiple simultaneous changes in style, and there is no need to disentangle them.

In particular,
the extracting of the semantic content c from the training image x, and/or
the obtaining of the style s based on the style source image y
   may be performed by feeding the training image x, respectively the style source image y, into a trained feature extractor network F that is configured to determine both a content c and a style s from an input image. This means that, for each of the training image x and the style source image y, a respective pair (c,s) of a content c and a style s is created. Only the content part c from the pair (c,s) corresponding to the training image x, and the style part s from the pair (c,s) corresponding to the style source image y, are used.

For example, the feature extractor network F may be trained in tandem with the generative model G such that, if a training image \tilde{x} is first decomposed into a pair (c,s) of a content c and a style s, and this pair (c,s) is fed to the generative model G, something close to the original training image \tilde{x} is reconstructed.

In a further advantageous example embodiment of the present invention, the style s is chosen to be an interpolation between a first style s′ of the training image x and a second style s″ of the style source image y. In this manner, based on one single style source image y, a plurality of style-augmented versions x′ of one and the same training image x may be generated.

For example, the training image x may have been taken during daytime, so its style s is that of a daytime image. The style source image y may have been taken at nighttime, so its style is that of a nighttime image. By style interpolation, various degrees of the dusk transition between daytime and nighttime may then be created as new styles and applied to content c of the training image x to create new augmented versions x′.

In particular, the style of the source image y being different from that of the training image x may mean that the style source image y differs from one or more training images x in at least one aspect that is distinct from the content c. As discussed before, it is not required to name this aspect explicitly. However, by choosing this aspect, it can be actively steered in which direction the manifold of images on which agreement between the student neural network and the teacher neural network will be checked is expanded.

For example, the aspect in which the style source image y differs from all training images x may specifically comprises one or more of:
a time of day at which the image was acquired;
a season of the year in which the image was acquired;
weather and/or lighting conditions under which the image was acquired;
imperfections and/or disturbances in the image; and
a camera setup with which the image was acquired.

These are typical variations that occur in real-world applications where input images are acquired by at least one sensor, and should not cause the student neural network that is being used in the application to suddenly divert in its behavior from the teacher neural network.

In a further particularly advantageous example embodiment of the present invention, at least one augmented version x′ of a training image x, and/or at least one style source image y, is obtained from a trained generative diffusion model D using a text prompt that is indicative of the desired style of the augmented version x′, respectively of the style source image y. In this manner, if an explicit notion of the desired style change is available, this can be rendered by the trained generative diffusion model D. For example, given the training image x, the generative diffusion model D may be instructed to create an augmented version x′ that still has a notion of the original training image x but is modified as per the text prompt. Depending on how strong an adherence to the original training image x is desired, on top of the style, the appearance of the content of the original training image x may be changed by the generative diffusion model D within the limits that this content still has the same semantic meaning in the application at hand. For example, if the original training image x shows a castle, and the generative diffusion model D is instructed to convert this into a wintertime image, on top of this style change, the number and appearance of the towers of the castle might be changed. But the castle will still remain a castle.

In a further particularly advantageous example embodiment of the present invention, feature maps outputted by intermediate layers of the respective neural network are chosen as intermediate work products. For example, these feature maps may be outputted by convolutional layers. In particular, feature maps of different sizes may be processed (e.g., by evaluating summaries of the features contained therein) such that it may be checked how much they are in agreement with one another.

In a further particularly advantageous example embodiment of the present invention, the outputs of the neural network are chosen to be logits, and/or other unaggregated results outputted by the neural network. In particular, logits are outputs that are not yet normalized by a normalization function, such as the softmax function. Furthermore, they are not yet condensed into a final decision, such as a one-hot vector of classification scores that is outputted by the final, fully-connected layer of a neural network that is used as a classifier. In this manner, even subtle differences between the behaviors of the teacher neural network and the student neural network may be captured.

In a further particularly advantageous example embodiment of the present invention, the loss function measures a distance between outputs and/or intermediate work products produced by the teacher neural network on the one hand, and by the student neural network on the other hand. This distance may, for example, be measured in a common space to which the outputs, respectively the intermediate work products, of the teacher and student neural networks belong. If there is no such common space, e.g., because the outputs, respectively the intermediate work products, are of different sizes, another option is to transform both outputs, respectively both work products, into a common working space and measure the distance in this working space.

For example, if there is a common space, a norm, such as the L2-norm, may be used as a distance measure. Also, in particular, the architecture of the student neural network may be chosen to comprise at least one layer or other building block whose output has the same dimensionality as the output of a corresponding layer or other building block in the given teacher neural network. In this manner, a distance between the outputs of the corresponding layers may be directly measured in a common space. An example for such a loss function L_{KD} is:

$${L}_{KD} = ‖ {f}_{c} - {f}_{s} ‖ ,$$

wherein fₜ and fₛ are the intermediate work products outputted by the teacher and student neural networks, respectively. Herein, the index KD stands for “knowledge distillation”.

In a further particularly advantageous example embodiment of the present invention, the Kullback-Leibler divergence is chosen as a measure for the distance. This distance measure was originally intended to measure a distance between distinct distributions and therefore does not require the outputs, respectively the work products, of both the teacher and student neural network to be in a same space. Optionally, the outputs, respectively the work products, may also be divided by a scalar temperature constant τ in order to smooth the outputs, respectively the work products. One example of such a loss function L_{KD} is:

$${L}_{KD} = K L ( {p}_{t} / τ , {p}_{s} / τ ) ,$$

wherein pₜ and pₛ are the outputs or intermediate work products (“predictions”) of the teacher and student neural networks, respectively.

In a further particularly advantageous example embodiment of the present invention, the student neural network is configured to produce outputs with respect to a given task. The training images x are labelled with ground truth with respect to this given task. The loss function further measures a difference and/or distance between the outputs produced from each training image x and the ground truth for the respective training image x. With Lₜₐₛₖ as the task loss, the total loss function L may then, for example, be:

$$L = {L}_{task} + {L}_{KD} .$$

In this manner, the student neural network may be trained both for a behavior corresponding to that of the teacher neural network and for solving the given task at the same time. For example, the given teacher neural network may be a generically trained foundation model that has been trained to perform a rather abstract processing of the input images on unlabeled data, whereas the student neural network may be trained towards solving a concrete task for which ground truth is available. Thus, rather than training a neural network for the given task from scratch, which is infeasible in many applications, the training of the student neural network may build upon the knowledge in the teacher neural network and refine this for the solving of the concrete task with only a small amount of training images x.

In a further particularly advantageous example embodiment of the present invention, the loss function further measures a difference and/or distance between the outputs produced from each augmented image version x′ and the ground truth for the training image x to which this augmented version x′ relates. Because the augmented image versions x′ have the same semantic content as the training image x to which they relate, the ground truth with which the training image x is annotated (“labelled”) is valid for the augmented versions x′ as well. Thus, the obtaining of augmented versions x′ as per the method proposed here also enlarges the pool of available training examples even for the supervised training to solve the given task, without incurring an additional overhead for labelling.

In a further particularly advantageous example embodiment of the present invention, the student neural network is configured as an image classifier, a semantic segmentation model, and/or as an object detector. These are typical tasks where a change in image style should not suddenly change the response of the student neural network. In this context, it is advantageous that the way of obtaining the augmented versions x′ presented here is not tied to the task of classification.

The ultimate goal of training the student neural network is to use this in a real application, and in particular on a hardware platform that does not admit the execution of the teacher neural network. Therefore, in a further particularly advantageous embodiment, input images that have been acquired using at least one sensor are provided to the trained student neural network. From the outcome of the trained student neural network, an actuation signal is determined. A vehicle, a driving assistance system, a robot, a surveillance system, a quality inspection system, and/or a medical imaging system, is then actuated with the actuation signal. In this manner, the probability that the reaction of the respective actuated technical system in response to actuation with the actuation signal is appropriate in the situation characterized by the acquired input images is increased. In particular, a sudden change in image style, such as a change from daytime to nighttime, or from summer conditions to winter conditions, will not trigger a sudden, unexpected change of behavior. For example, when a car travels across the alps through a tunnel, the conditions on both ends of the tunnel may be completely different.

The method may be wholly or partially computer-implemented and embodied in software. The present invention therefore also relates to a computer program with machine-readable instructions that, when executed by one or more computers and/or compute instances, cause the one or more computers and/or compute instances to perform the method of the present invention described above. Herein, control units for vehicles or robots and other embedded systems that are able to execute machine-readable instructions are to be regarded as computers as well. Compute instances comprise virtual machines, containers or other execution environments that permit execution of machine-readable instructions in a cloud.

A non-transitory machine-readable data carrier, and/or a download product, may comprise the computer program. A download product is an electronic product that may be sold online and transferred over a network for immediate fulfilment. One or more computers and/or compute instances may be equipped with said computer program, and/or with said non-transitory storage medium and/or download product.

In the following, the present invention is described using Figures without any intention to limit the scope of the present invention.

### BRIEF DESCRIPTION OF THE DRAWINGS

FIG. 1 show an exemplary embodiment of the method 100 for training a student neural network 2, according to the present invention.

FIGS. 2A and 2B show exemplary ways of comparing the behaviors of the teacher neural network 1 and the student neural network 2 based on outputs 1b, 2b (FIG. 2A) and intermediate work products 1a, 2a (FIG. 2B).

FIG. 3 shows Exemplary data augmentation for the training towards solving a given task using unlabeled style source images y.

### DETAILED DESCRIPTION OF EXAMPLE EMBODIMENTS

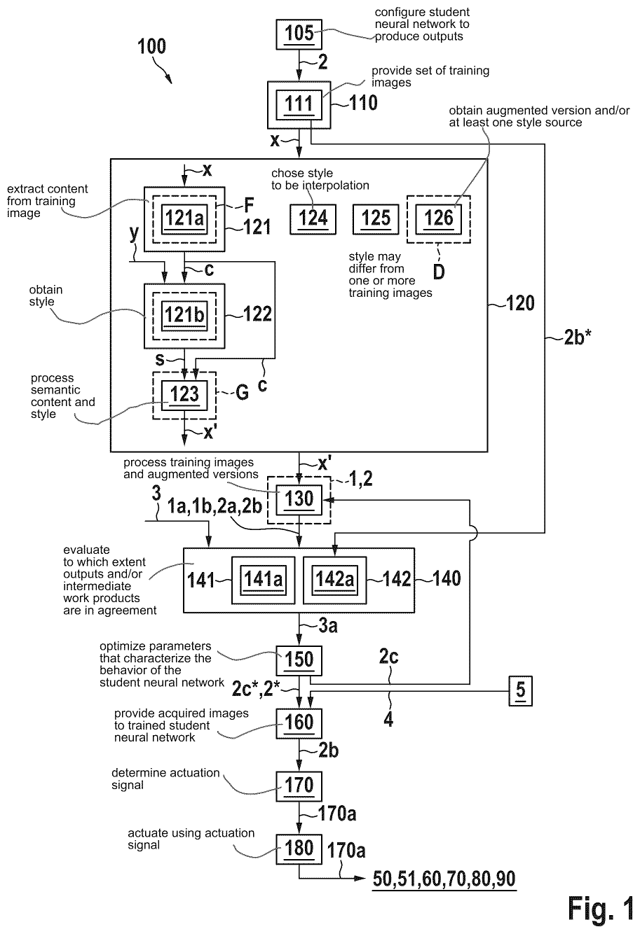

FIG. 1 is a schematic flow chart of an example of the method 100 for training a student neural network 2 to adopt the behavior of a given teacher neural network 1. This teacher neural network 1 is trained to perform a given processing on input images.

In step 110, a set of training images x is provided.

Optionally, according to block 105, the student neural network 2 may be configured to produce outputs 2b with respect to a given task. According to block 111, the training images x may then be labelled with ground truth 2b* with respect to this given task.

In step 120, from at least one training image x, one or more style-augmented versions x′ are produced. These style-augmented versions x′ have the same semantic content as the original training image x, but at the same time differ from this original training image x in their style.

According to block 121, a content c may be extracted from the training image x. According to block 122, a style s may be obtained based at least in part on a style source image y. According to block 123, the semantic content c and the style s may then be processed into the sought augmented version x′ by a trained generative model G.

According to block 121a, respectively 122a, the extracting 121, respectively the obtaining 122, may be performed by feeding the training image x, respectively the style source image y, into a trained feature extractor network F that is configured to determine both a content c and a style s from an input image.

According to block 124, the style s may be chosen to be an interpolation between a first style s′ of the training image x and a second style s″ of the style source image y.

According to block 125, the style source image y may differ from one or more training images x in at least one aspect that is distinct from the content c.

According to block 126, at least one augmented version x′ of a training image x, and/or at least one style source image y, may be obtained from a trained generative diffusion model D using a text prompt that is indicative of the desired style of the augmented version x′, respectively of the style source image y.

In step 130, the training images x and the augmented versions x′ are processed.
by the teacher neural network 1 on the one hand, which produces intermediate work products 1a and outputs 1b; and
by the student neural network 2 on the one hand, which produces intermediate work products 2a and outputs 2b.

In step 140, using a predetermined loss function 3, it is evaluated to which extent outputs 2b and/or intermediate work products 2a produced by the student neural network 2 from each image x, x′ are in agreement with the outputs 1b and/or intermediate work products 1a produced by the teacher neural network 1 from the same image x, x′. The outcome of the loss function 3 is a value 3a.

According to block 141, the loss function 3 may measure a distance between outputs 1b; 2b and/or intermediate work products 1a; 2a produced by the teacher neural network 1 on the one hand, and by the student neural network 2 on the other hand. In particular, according to block 141a, the Kullback-Leibler divergence may be chosen as a measure for the distance.

According to block 142, if the student neural network 2 is configured to solve a particular task according to block 105 and training images x are labelled with corresponding ground truth 2b*, the loss function 3 may further measure a difference and/or distance between the outputs 2b produced from each training image x and the ground truth 2b* for the respective training image x.

In particular, according to block 142a, the loss function 3 may further measure a difference and/or distance between the outputs 2b produced from each augmented image version x′ and the ground truth 2b* for the training image x to which this augmented version x′ relates.

In step 150, parameters 2c that characterize the behavior of the student neural network 2 are optimized towards the goal of improving the value 3a of the loss function 3. The finally optimized state of the parameters 2c is labelled with the reference sign 2c* and also characterizes the fully trained state 2* of the student neural network 2.

In the example shown in FIG. 1, in step 160, input images 4 that have been acquired using at least one sensor 5 are provided to the trained student neural network 2*. The trained student neural network 2* then produces an output 2b.

From this output 2b, in step 170, an actuation signal 170a is determined. In step 180, a vehicle 50, a driving assistance system 51, a robot 60, a surveillance system 70, a quality inspection system 80, and/or a medical imaging system 90, is actuated with this actuation signal 170a.

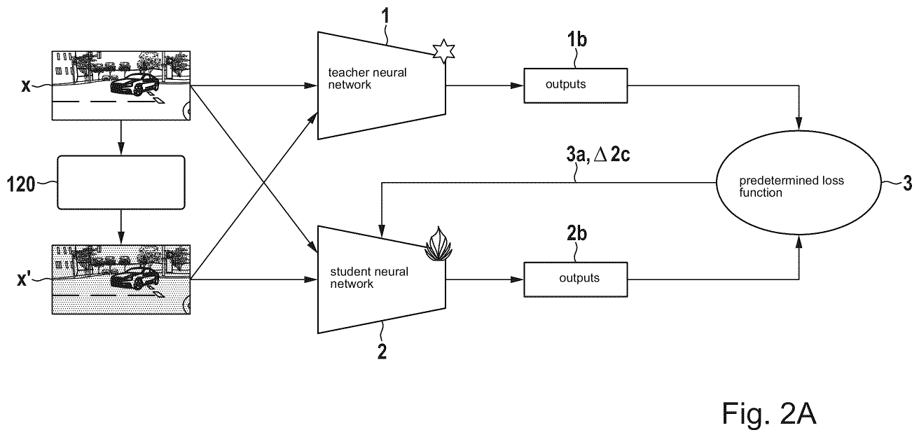

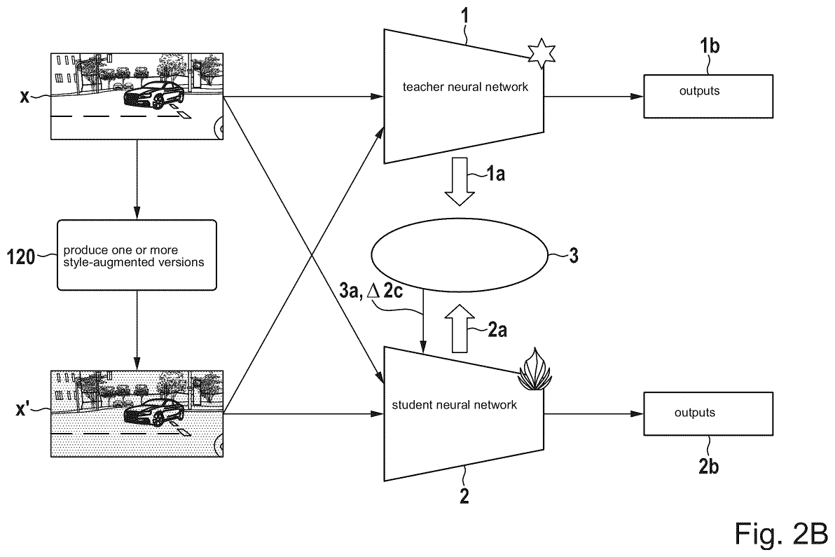

FIGS. 2A and 2B show exemplary ways of comparing the behaviors of the teacher neural network 1 and the student neural network 2.

In the example shown in FIG. 2A, from the training image x, an augmented version x′ is created according to step 120 of the method 100. Here, the training image x showing a vehicle on a road was taken during daytime, but the new style applied to it is that of a nighttime image. Thus, the resulting augmented version x′ shows the same vehicle on the same road as in the original training image x, but at nighttime. Both the training image x and the augmented version x′ are provided to both the teacher neural network 1 and the student neural network 2. The teacher neural network 1 produces outputs 1b, whereas the student neural network 2 produces outputs 2a. These outputs 1b and 2b are compared by the loss function 3. The snowflake symbol on the box representing the teacher neural network 1 signifies that the parameters that characterize the behavior of the teacher neural network 1 remain frozen. The flame symbol on the box representing the student neural network 2 signifies that the parameters 2c that characterize the behavior of the student neural network 2 are being optimized. That is, based on the value 3a of the loss function 3, an update Δ2c for the parameters 2c of the student neural network 2 is computed and fed back to the student neural network 2.

In the example shown in FIG. 2B, the augmented version x′ is created from the training image x just as this is shown in FIG. 2A. Also, in line with FIG. 2A, both the training image x and the augmented version x′ are provided to both the teacher neural network 1 and the student neural network 2. However, in contrast to FIG. 2A, intermediate work products 1a and 2a produced by the teacher neural network 1 and the student neural network 2 are considered by the loss function 3. In a manner analogous to FIG. 2A, an update Δ2c for the parameters 2c of the student neural network 2 is computed and fed back to the student neural network 2. Meanwhile, the parameters of the teacher neural network 1 remain frozen.

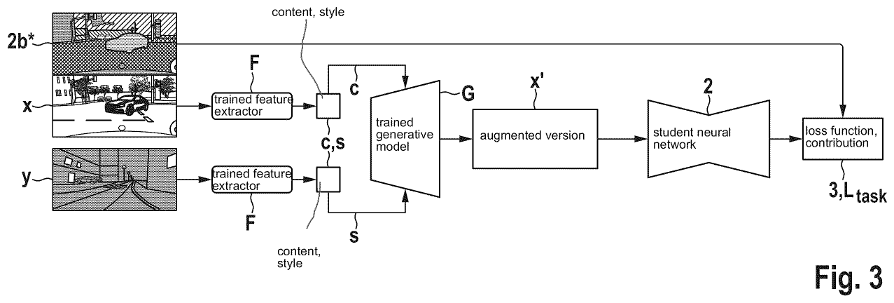

FIG. 3 illustrates how the data augmentation presented above can also be used for the supervised training of the student neural network 2 towards solving a given task using unlabeled style source images y. In the example shown in FIG. 3, the given task to be solved is semantic segmentation. The training image x and the augmented version x′ are the same as in FIGS. 2A and 2B. In addition, the source style image y from which the nighttime style was derived is shown.

Both the training image x and the source style image y are decomposed, by a trained feature extractor F, into a respective content c and style s. The content c derived from the training image x and the style derived from the source style image y are processed, by a trained generative model G, into the augmented version x′.

The training images x are labelled with corresponding ground truth 2b*. Because the augmented version x′ has the same semantic content, it can be used to train the student neural network 2 towards the task of semantic segmentation just as well. Fulfilment of the task is measured according to the loss function 3 and its contribution Lₜₐₛₖ presented above.

What is claimed is:

1. A method for training a student neural network to adopt the behavior of a teacher neural network that is trained to perform a given processing on input images, comprising the following steps:
providing a set of training images;
producing, from at least one training image from the set of training images, one or more style-augmented versions that:
have the same semantic content as the training image but
differ from the training image in their style;
processing the training image and the style-augmented versions, by the teacher neural network on the one hand, and by the student neural network on the other hand;
evaluating, using a predetermined loss function, to which extent outputs and/or intermediate work products produced by the student neural network from the one training image and the style-augmented versions are in agreement with outputs and/or intermediate work products produced by the teacher neural network from the same training image and style-augmented versions; and
optimizing parameters that characterize behavior of the student neural network towards a goal of improving a value of the loss function.

2. The method of claim 1, wherein the producing of each style-augmented version of the training image includes:
extracting, from the training image, a semantic content;
obtaining, based at least in part on a style source image, a style; and
processing, by a trained generative model, the semantic content and the style into the style-augmented version.

3. The method of claim 2, wherein:
(i) the extracting of the semantic content from the training image, and/or (ii) the obtaining of the style based on the style source image, is performed by feeding the training image and the style source image, into a trained feature extractor network that is configured to determine both a semantic content and a style from an input image.

4. The method of claim 2, wherein the style is chosen to be an interpolation between a first style of the training image and a second style of the style source image.

5. The method of claim 2, wherein the style source image differs from one or more training images in at least one aspect that is distinct from the semantic content.

6. The method of claim 5, wherein the aspect in which the style source image differs from all training images includes one or more of:
a time of day at which the style source image was acquired;
a season of the year in which the style source image was acquired;
weather and/or lighting conditions under which the style source image was acquired;
imperfections and/or disturbances in the style source image; and
a camera setup with which the style source image was acquired.

7. The method of claim 2, wherein at least one augmented version of a training image, and/or at least one style source image, is obtained from a trained generative diffusion model using a text prompt that is indicative of a desired style of the style-augmented version.

8. The method of claim 1, wherein feature maps outputted by intermediate layers of the teacher and the student neural networks are chosen the intermediate work products of the teach and student neural networks, respectively.

9. The method of claim 1, wherein the outputs of the teacher and the student neural networks are chosen to be logits, and/or other unaggregated results outputted by the teacher and the student neural networks, respectively.

10. The method of claim 1, wherein the loss function measures a distance between outputs and/or intermediate work products produced by the teacher neural network on the one hand, and by the student neural network on the other hand.

11. The method of claim 10, wherein the Kullback-Leibler divergence is chosen as a measure for the distance.

12. The method of claim 1, wherein:
the student neural network is configured to produce outputs with respect to a given task;
the training images are labelled with ground truth with respect to the given task; and
the loss function further measures a difference and/or distance between the outputs produced from each training image and the ground truth for the respective training image.

13. The method of claim 12, wherein the loss function further measures a difference and/or distance between the outputs produced from each style-augmented image version and a ground truth for a training image to which the style-augmented version relates.

14. The method of claim 1, wherein the student neural network is configured as an image classifier, and/or a semantic segmentation model, and/or an object detector.

15. The method of claim 1, further comprising:
providing input images that have been acquired using at least one sensor to the trained student neural network;
determining an actuation signal from an output of the trained student neural network based on the provided input images; and
actuating, using the actuation signal, a vehicle, a driving assistance system, and/or a robot, and/or a surveillance system, and/or a quality inspection system, and/or a medical imaging system.

16. A non-transitory machine-readable data carrier on which is stored a computer program including machine-readable instructions for training a student neural network to adopt the behavior of a teacher neural network that is trained to perform a given processing on input images, the instructions, when executed by one or more computers and/or compute instances, cause the one or more computers and/or compute instances to perform the following steps:
providing a set of training images;
producing, from at least one training image from the set of training images, one or more style-augmented versions that:
have the same semantic content as the training image but
differ from the training image in their style;
processing the training image and the style-augmented versions, by the teacher neural network on the one hand, and by the student neural network on the other hand;
evaluating, using a predetermined loss function, to which extent outputs and/or intermediate work products produced by the student neural network from the one training image and the style-augmented versions are in agreement with outputs and/or intermediate work products produced by the teacher neural network from the same training image and style-augmented versions; and
optimizing parameters that characterize behavior of the student neural network towards a goal of improving a value of the loss function.

17. One or more computers and/or compute instances having a non-transitory machine-readable data carrier on which is stored a computer program including machine-readable instructions for training a student neural network to adopt the behavior of a teacher neural network that is trained to perform a given processing on input images, the instructions, when executed by the one or more computers and/or compute instances, cause the one or more computers and/or compute instances to perform the following steps:
providing a set of training images;
producing, from at least one training image from the set of training images, one or more style-augmented versions that:
have the same semantic content as the training image but
differ from the training image in their style;
processing the training image and the style-augmented versions, by the teacher neural network on the one hand, and by the student neural network on the other hand;
evaluating, using a predetermined loss function, to which extent outputs and/or intermediate work products produced by the student neural network from the one training image and the style-augmented versions are in agreement with outputs and/or intermediate work products produced by the teacher neural network from the same training image and style-augmented versions; and
optimizing parameters that characterize behavior of the student neural network towards a goal of improving a value of the loss function.
